(19) United States
(12) Patent Application Publication
(10) Pub. No.: US 2026/0202975 A1
(43) Pub. Date: Jul. 16, 2026

(54) MEMORY CONTROLLER, MEMORY SYSTEM, AND OPERATING METHOD THEREOF

(71) Applicant: Yangtze Memory Technologies Co., Ltd., Wuhan (CN)

(72) Inventors: Wenjie MU, Wuhan (CN); Jiawei CHEN, Wuhan (CN); Weihua SHI, Wuhan (CN); Tingting ZHOU, Wuhan (CN)

(21) Appl. No.: 19/070,855

(22) Filed: Mar. 5, 2025

Related U.S. Application Data
(63) Continuation of application No. PCT/CN2025/071989, filed on Jan. 13, 2025.

(51) Int. Cl. G06F 3/06

(52) U.S. Cl. CPC G06F 3/0625; G06F 3/0634; G06F 3/0656; G06F 3/0679

(57) ABSTRACT

The present disclosure relates to memory controllers, memory systems, and operating methods thereof. An example memory system includes a memory controller, a buffer chip coupled to the memory controller, and a first group of memory devices. In some implementations, a first data path is coupled between the buffer chip and the first group of memory devices. The memory system further includes a second group of memory devices. In some implementations, a second data path is coupled between the buffer chip and the second group of memory devices. The buffer chip can be configured to control the first data path and the second data path based on control signaling received from the memory controller.

### CROSS-REFERENCE TO RELATED APPLICATIONS

This application is a continuation of International Application No. PCT/CN2025/071989, filed on Jan. 13, 2025, the disclosure of which is hereby incorporated by reference in its entirety.

### TECHNICAL FIELD

The present disclosure relates to memory controllers, memory systems, and operating methods thereof.

### BACKGROUND

Semiconductor memory devices can be categorized into volatile memory devices and non-volatile memory devices. The volatile memory devices lost data when power is off. The non-volatile memory devices can retain stored data when power is not connected. Flash memory is a low-cost and high-density non-volatile memory device, which includes NOR flash memory and NAND flash memory. Various operations, such as read, program (write), and erase, can be performed by the flash memory.

### SUMMARY

The present disclosure generally relates to memory controllers and memory systems, and in particular, to memory systems including a buffer chip and operating methods thereof.

One aspect of the present disclosure features a memory system. The memory system includes a memory controller, a buffer chip coupled to the memory controller, and a first group of memory devices. In some implementations, a first data path is coupled between the buffer chip and the first group of memory devices. The memory system further includes a second group of memory devices. In some implementations, a second data path is coupled between the buffer chip and the second group of memory devices, and the buffer chip is configured to control the first data path and the second data path based on control signaling received from the memory controller.

In some implementations, the buffer chip is configured to receive a first data signal from the memory controller and forward the first data signal to the first data path or the second data path without shaping the first data signal, and receive a second data signal from the first data path or the second data path and forward the second data signal to the memory controller without shaping the second data signal.

In some implementations, the buffer chip can include a first group of data pins coupled to the first group of memory devices through the first data path, and a second group of data pins coupled to the second group of memory devices through the second data path. The buffer chip is configured to forward a data signal from the memory controller to the first data path through the first group of data pins or to the second data path through the second group of data pins.

In some implementations, the buffer chip can further include a third group of data pins, first control pins, and second control pins. The third group of data pins, the first control pins, and the second control pins are coupled to the memory controller.

In some implementations, the first control pins can include a first chip enable pin coupled to the memory controller and the first group of memory devices, and a second chip enable pin coupled to the memory controller and the second group of memory devices. The second control pins can include a command latch enable pin and an address latch enable pin. The command latch enable pin and the address latch enable pin are coupled to the memory controller, the first group of memory devices, and the second group of memory devices.

In some implementations, the buffer chip is configured to switch between a legacy mode and a separate command address (SCA) mode based on a control signal from the memory controller.

In some implementations, the buffer chip is in the legacy mode, and the control signaling includes a first chip enable signal and a second chip enable signal received from the memory controller through the first chip enable pin and the second chip enable pin respectively.

In some implementations, the buffer chip is in the SCA mode, the control signaling includes a command latch enable signal and an address latch enable signal received from the memory controller through the command latch enable pin and the address latch enable pin respectively, and the buffer chip is configured to determine an SCA message based on at least the command latch enable signal, the address latch enable signal, and an SCA protocol.

In some implementations, the SCA message can include a header and a body. In response to determining that the header indicates a predetermined SCA message type, the buffer chip is configured to perform one of the following operations based on the body: disabling the first data path and the second data path; enabling the first data path and disabling the second data path; disabling the first data path and enabling the second data path; or enabling the first data path and the second data path.

In some implementations, the buffer chip can include: a first circuit coupled to the first control pins and the second control pins; and a second circuit coupled to the first group of data pins, the second group of data pins, and the third group of data pins. The first circuit is configured to operate in a first voltage domain, and the second circuit is configured to operate in a second voltage domain.

In some implementations, the second circuit can include: a first group of switches coupled between the first group of data pins and the third group of data pins; and a second group of switches coupled between the second group of data pins and the third group of data pins.

In some implementations, the first group of memory devices can include four memory devices, and the second group of memory devices can include four memory devices.

Another aspect of the present disclosure features a memory controller. The memory controller includes first control pins, second control pins, and data pins. The first control pins, the second control pins, and the data pins are coupled to a buffer chip. The data pins are coupled to a first group of memory devices through the buffer chip and a first data path between the buffer chip and the first group of memory devices. The data pins are coupled to a second group of memory devices through the buffer chip and a second data path between the buffer chip and the second group of memory devices. The first control pins are coupled to the buffer chip, the first group of memory devices, and the second group of memory devices. The second control pins are coupled to the buffer chip, the first group of memory devices, and the second group of memory devices.

In some implementations, the first control pins can include a first chip enable pin coupled to the buffer chip and the first group of memory devices and a second chip enable pin coupled to the buffer chip and the second group of memory devices. The memory controller is configured to: in response to determining that the buffer chip is in a legacy mode, transmit a first chip enable signal from the first chip enable pin and a second chip enable signal from the second chip enable pin.

In some implementations, the second control pins can include a command latch enable pin and an address latch enable pin coupled to the buffer chip. The memory controller is configured to: in response to determining that the buffer chip is in a separate command address (SCA) mode, transmit a command latch enable signal from the command latch enable pin and an address latch enable signal from the address latch enable pin based on an SCA protocol.

Another aspect of the present disclosure features a method of operating a memory system. The method includes determining, by a memory controller of the memory system, an operating mode of a buffer chip of the memory system. The buffer chip is coupled to the memory controller and memory devices of the memory system. The operating mode can include a legacy mode and a separate command address (SCA) mode, and the memory devices can include a first group of memory devices coupled to the buffer chip through a first data path and a second group of memory devices coupled to the buffer chip through a second data path. The method further includes transmitting, by the memory controller, control signaling to the buffer chip based on the operating mode. The control signaling requests the buffer chip to control the first data path and the second data path.

In some implementations, transmitting the control signaling to the buffer chip based on the operating mode can include: in response to determining that the operating mode is the legacy mode, transmitting a first chip enable signal from a first chip enable pin of the memory controller and a second chip enable signal from a second chip enable pin of the memory controller. The first chip enable signal indicates the buffer chip to enable or disable the first group of memory devices, and the second chip enable signal indicates the buffer chip to enable or disable the second group of memory devices.

In some implementations, transmitting the control signaling to the buffer chip based on the operating mode can include: in response to determining that the operating mode is the SCA mode, transmitting an SCA message using a command latch enable signal and an address latch enable signal. The SCA message can include a header and a body. The header indicates an SCA message type. The body indicates the buffer chip to perform one of the following operations: disabling the first data path and the second data path; enabling the first data path and disabling the second data path; disabling the first data path and enabling the second data path; or enabling the first data path and the second data path.

In some implementations, the command latch enable signal is transmitted from a command latch enable pin of the memory controller, and the address latch enable signal is transmitted from an address latch enable pin of the memory controller.

In some implementations, determining the operating mode of the buffer chip can include: determining the operating mode of the buffer chip based on a voltage level at a status pin of the buffer chip.

The details of one or more implementations of the subject matter of this present disclosure are set forth in the accompanying drawings and the description below. Other features, aspects, and advantages of the subject matter will become apparent from the description, the drawings, and the claims.

### BRIEF DESCRIPTION OF DRAWINGS

FIG. 1 illustrates an example of a schematic diagram of a memory device including peripheral circuits.

FIG. 2 illustrates an example of a side view of cross-sections of a memory cell array including NAND memory strings.

FIG. 3 illustrates an example of a schematic diagram of some peripheral circuits.

FIGS. 4A-4B illustrate example memory systems.

FIGS. 5A-5B illustrate example operations of a memory controller and a buffer chip.

FIG. 6 illustrates an example decoding process of command address (CA) commands.

FIGS. 7A-7B illustrate example buffer chips.

FIG. 8 illustrates a flowchart of an example method performed by a memory controller.

FIG. 9 illustrates a block diagram of an example system having a memory device.

FIG. 10A illustrates a diagram of a memory card having a memory device.

FIG. 10B illustrates a diagram of a solid-state drive (SSD) having a memory device.

Like reference numbers and designations in the various drawings indicate like elements.

It is also to be understood that the various exemplary implementations shown in the figures are merely illustrative representations and are not necessarily drawn to scale.

### DETAILED DESCRIPTION

As the high-performance computing and data-intensive applications continue to grow, memory systems are required to handle larger volumes of data with greater speed and efficiency. In addition, to meet a demand for cheaper and higher-density storage products, a large number of memory devices (e.g., a 3D NAND flash memory) are included in a memory system. However, the number of data channels in the memory system can be limited due to physical and architectural constraints. The approach of integrating more memory devices within the memory system, while effective in increasing storage density, can introduce significant challenges. In particular, the addition of more memory devices can increase the electrical load on the channel, resulting in higher parasitic capacitance and impedance. These factors can negatively impact the signal integrity and reduce the input/output (I/O) rate of the memory system. Consequently, the overall performance of the memory system may degrade, particularly in high-speed and high-capacity configurations.

There is a need for improved memory system designs and techniques that mitigate these limitations, enabling higher memory capacity and maintaining reliable data transfer rates without compromising system efficiency.

In one or more implementations of the present disclosure, an example memory system is provided. The memory system includes a memory controller, a buffer chip coupled to the memory controller, and multiple groups of memory devices. In some implementations, a first data path is coupled between the buffer chip and a first group of memory devices, and a second data path is coupled between the buffer chip and a second group of memory devices. The buffer chip can be configured to control the first data path and the second data path based on control signaling received from the memory controller.

Implementations of the present disclosure can provide one or more of the following technical advantages and/or benefits. The described buffer chip can be configured to isolate the load of non-target memory devices on the data path during memory access. This isolation can effectively reduce the overall electrical burden on data channel of the memory system, thereby enhancing the I/O rate and improving data transmission efficiency, particularly in scenarios requiring high-speed communication and high-density memory configurations. The buffer chip can use a passive design, which can minimize power consumption of the memory system and contribute to lower operating costs and improved thermal management. This low power design makes the described memory system suitable for applications where energy efficiency is critical, such as mobile devices, data centers, and edge computing platforms. The buffer chip's compatibility with both the Separate Command Address (SCA) protocol and the legacy protocol provides superior adaptability across various system architectures. Furthermore, the described buffer chip includes circuits operating in different power domains. Such buffer chips can be manufactured using fully depleted silicon-on-insulator (FDSOI) techniques, which can integrate high voltage transistors and low voltage transistors in a same semiconductor structure without significant process adjustment. The described techniques can simplify the manufacturing process and reduce production costs.

The techniques can be applied to various types of semiconductor devices, volatile memory devices, such as DRAM memory devices, or non-volatile memory (NVM) devices, such as NAND flash memory, NOR flash memory, resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to three-dimensional (3D) memory devices. The techniques can be applied to various memory types, such as SLC (single-level cell) devices, MLC (multi-level cell) devices like 2-level cell devices, TLC (triple-level cell) devices, QLC (quad-level cell) devices, or PLC (penta-level cell) devices. Additionally or alternatively, the techniques can be applied to various types of devices and systems, such as secure digital (SD) cards, embedded multimedia cards (eMMC), or solid-state drives (SSDs), embedded systems, among others.

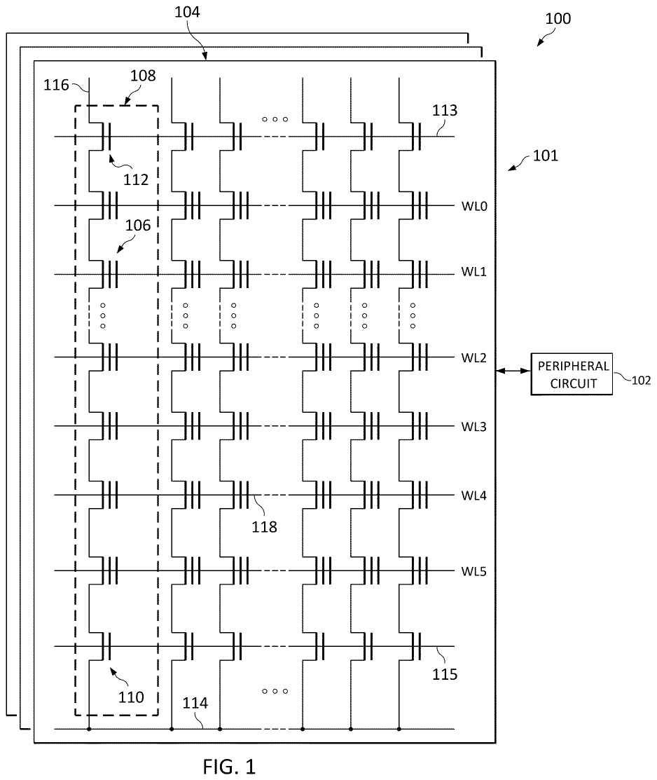

FIG. 1 illustrates an example of a schematic circuit diagram of a memory device 100 including peripheral circuits, according to some aspects of the present disclosure. Memory device 100 can include a memory cell array 101 and peripheral circuits 102 coupled to memory cell array 101. Memory cell array 101 can be a NAND flash memory cell array in which memory cells 106 are provided in the form of an array of memory strings 108 (e.g., NAND memory strings) each extending vertically above a substrate (not shown). In some implementations, each NAND memory string 108 includes a plurality of memory cells 106 coupled in series and stacked vertically. Each memory cell 106 can hold a continuous, analog value, such as an electrical voltage or charge that depends on the number of electrons trapped within a region of memory cell 106. Each memory cell 106 can be either a floating gate type of memory cell including a floating-gate transistor or a charge trap type of memory cell including a charge-trap transistor.

In some implementations, each memory cell 106 is a single-level cell (SLC) that has two possible memory states and thus, can store one bit of data. For example, the first memory state “0” can correspond to a first range of voltages, and the second memory state “1” can correspond to a second range of voltages. In some implementations, each memory cell 106 is a multi-level cell (MLC) that is capable of storing more than a single bit of data in more than four memory states. For example, the MLC can store two bits per cell, three bits per cell (also known as triple-level cell (TLC)), or four bits per cell (also known as a quad-level cell (QLC)). Each MLC can be programmed to assume a range of possible nominal storage values. In one example, if each MLC stores two bits of data, then the MLC can be programmed to assume one of three possible programming levels from an erased state by writing one of three possible nominal storage values to the cell. A fourth nominal storage value can be used for the erased state.

As shown in FIG. 1 each NAND memory string 108 can include a source select gate (SSG) 110 at its source end and a drain select gate (DSG) 112 at its drain end. SSG 110 can be referred to as a bottom select gate (BSG), and DSG 112 can be referred to as a top select gate (TSG). BSG 110 and TSG 112 can be configured to activate selected NAND memory strings 108 (columns of the array) during read and program operations. In some implementations, the sources of NAND memory strings 108 in the same block 104 are coupled through a same source line (SL) 114, e.g., a common SL. In other words, NAND memory strings 108 in the same block 104 have an array common source (ACS), according to some implementations. TSG 112 of each NAND memory string 108 is coupled to a respective bit line 116 from which data can be read or written via an output bus (not shown), according to some implementations. In some implementations, each NAND memory string 108 is configured to be selected or deselected by applying a select voltage (e.g., above the threshold voltage of the transistor having TSG 112) or a deselect voltage (e.g., 0 V) to respective TSG 112 through one or more TSG lines 113, and/or by applying a select voltage (e.g., above the threshold voltage of the transistor having BSG 110) or a deselect voltage (e.g., 0 V) to respective BSG 110 through one or more BSG lines 115. In some implementations, NAND memory string 108 includes the bottom memory cell abutted BSG 110 and the top memory cell abutted TSG 112, where the bottom memory cell is coupled to the bottom word line, for example, WL5 shown in FIG. 1, and the top memory cell is coupled to the top word line, for example, WL0 shown in FIG. 1.

As shown in FIG. 1, NAND memory strings 108 can be organized into multiple blocks 104, each of which can have a common source line 114, e.g., coupled to the ACS. In some implementations, each block 104 is the basic data unit for erase operations, i.e., all memory cells 106 on the same block 104 are erased at the same time. To erase memory cells 106 in a selected block 104, source lines 114 coupled to selected block 104 as well as unselected blocks 104 in the same plane as selected block 104 can be biased with an erase voltage (Verase), such as a high positive voltage (e.g., 20V or more). In some examples, erase operation may be performed at a half-block level, a quarter-block level, or a level having any suitable number of blocks or any suitable fractions of a block. Memory cells 106 of adjacent NAND memory strings 108 can be coupled through word lines 118 that select which row of memory cells 106 is affected by read and program operations. Example word lines shown in FIG. 1 include top word line WL0, WL1, WL2, WL3, WL4, and bottom word line WL5 that are between one or more TSG lines 113 and one or more BSG lines 115.

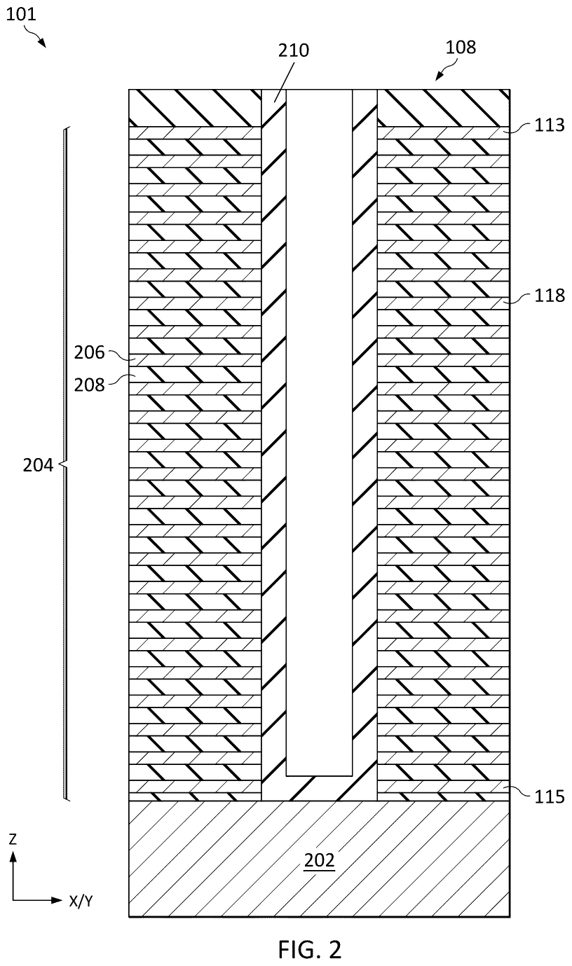

FIG. 2 illustrates an example of a side view of cross-sections of a memory cell array 101 including NAND memory strings 108, according to some aspects of the present disclosure. As shown in FIG. 2, NAND memory string 108 can extend vertically through a memory stack 204 above a substrate 202. Substrate 202 can include silicon (e.g., single crystalline silicon), silicon germanium (SiGe), gallium arsenide (GaAs), germanium (Ge), silicon on insulator (SOI), germanium on insulator (GOI), or any other suitable materials.

Memory stack 204 can include interleaved gate conductive layers 206 and gate-to-gate dielectric layers 208. The number of the pairs of gate conductive layers 206 and gate-to-gate dielectric layers 208 in memory stack 204 can determine the number of memory cells 106 in memory cell array 101. Gate conductive layer 206 can include conductive materials including, but not limited to, tungsten (W), cobalt (Co), copper (Cu), aluminum (Al), polysilicon, doped silicon, silicides, or any combination thereof. In some implementations, each gate conductive layer 206 includes a metal layer, such as a tungsten layer. In some implementations, each gate conductive layer 206 includes a doped polysilicon layer. Each gate conductive layer 206 can include control gates surrounding memory cells 106, TSG 112, or BSG 110, and can extend laterally as TSG line 113 at the top of memory stack 204, BSG line 115 at the bottom of memory stack 204, or word line 118 between TSG line 113 and BSG line 115.

As shown in FIG. 2, NAND memory string 108 includes a channel 210 extending vertically through memory stack 204. In some implementations, channel 210 includes multiple layers each formed of a different material (e.g., a semiconductor material or a dielectric material).

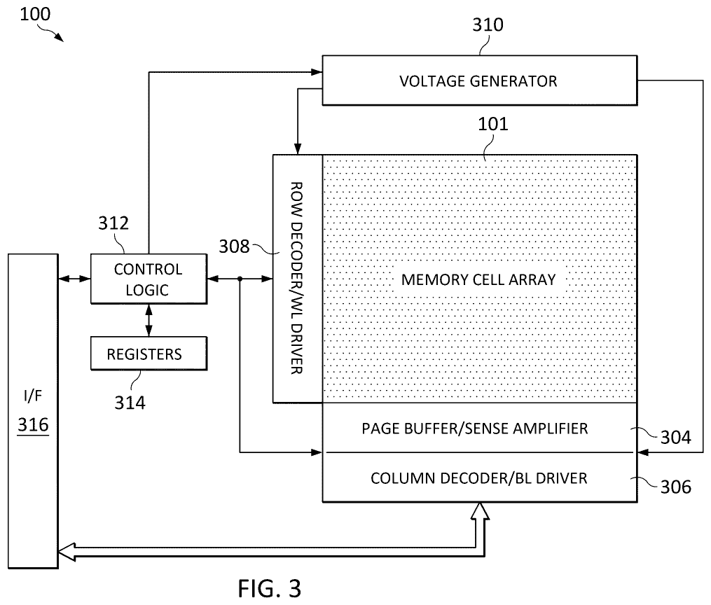

FIG. 3 illustrates some example peripheral circuits, according to some aspects of the present disclosure. The example peripheral circuits include a page buffer/sense amplifier 304, a column decoder/bit line driver 306, a row decoder/word line driver 308, a voltage generator 310, control logic 312, registers 314, an interface 316, and a data bus. In some examples, additional peripheral circuits not shown in FIG. 3 may be included as well. Peripheral circuits 102 can be coupled to memory cell array 101 through bit lines 116, word lines 118, source lines 114, BSG lines 115, and TSG lines 113 of FIG. 1. Peripheral circuits 102 can include any suitable analog, digital, and mixed-signal circuits for facilitating the operations of memory cell array 101 by applying and sensing voltage signals and/or current signals to and from each target memory cell 106 through bit lines 116, word lines 118, source lines 114, BSG lines 115, and TSG lines 113. Peripheral circuits 102 can include various types of peripheral circuits formed using metal-oxide-semiconductor (MOS) technologies.

Page buffer/sense amplifier 304 can be configured to read and program (write) data from and to memory cell array 101 according to the control signals from control logic 312. In one example, page buffer/sense amplifier 304 may store one page of program data (write data) to be programmed into one page of memory cell array 101. In another example, page buffer/sense amplifier 304 may perform program verify operations to ensure that the data has been properly programmed into memory cells 106 coupled to selected word lines 118. In still another example, page buffer/sense amplifier 304 may also sense the low power signals from bit line 116 that represents a data bit stored in memory cell 106 and amplify the small voltage swing to recognizable logic levels in a read operation. Column decoder/bit line driver 306 can be configured to be controlled by control logic 312 and select one or more NAND memory strings 108 by applying bit line voltages generated from voltage generator 310.

Row decoder/word line driver 308 can be configured to be controlled by control logic 312 and select/deselect blocks 104 of memory cell array 101 and select/deselect word lines 118 of block 104. Row decoder/word line driver 308 can be further configured to drive word lines 118 using word line voltages generated from voltage generator 310. In some implementations, row decoder/word line driver 308 can also select/deselect and drive BSG lines 115 and TSG lines 113 as well. As described below in detail, row decoder/word line driver 308 is configured to apply a read voltage to selected word line 118 in a read operation on memory cell 106 coupled to selected word line 118.

Voltage generator 310 can be configured to be controlled by control logic 312 and generate the word line voltages (e.g., read voltage, program voltage, pass voltage, local voltage, verification voltage, etc.), bit line voltages, and source line voltages to be supplied to memory cell array 101.

Control logic 312 can be coupled to each peripheral circuit described above and configured to control operations of each peripheral circuit. Registers 314 can be coupled to control logic 312 and include status registers, command registers, and address registers for storing status information, command operation codes (OP codes), and command addresses for controlling the operations of each peripheral circuit. As described below in detail, the status registers of registers 314 can include one or more registers configured to store open block information indicative of the open block(s) of all blocks 104 in memory cell array 101. In some implementations, the open block information is also indicative of the last programmed page of each open block.

Interface 316 can be coupled to control logic 312 and act as a control buffer to buffer and relay control commands received from a host (not shown) to control logic 312 and status information received from control logic 312 to the host. Interface 316 can also be coupled to column decoder/bit line driver 306 via a data bus and act as a data input/output (I/O) interface and a data buffer to buffer and relay the data to and from memory cell array 101.

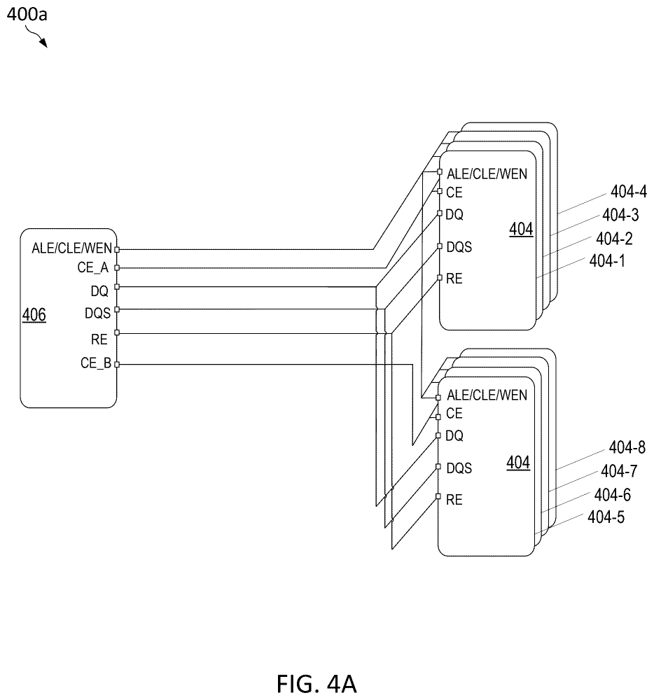

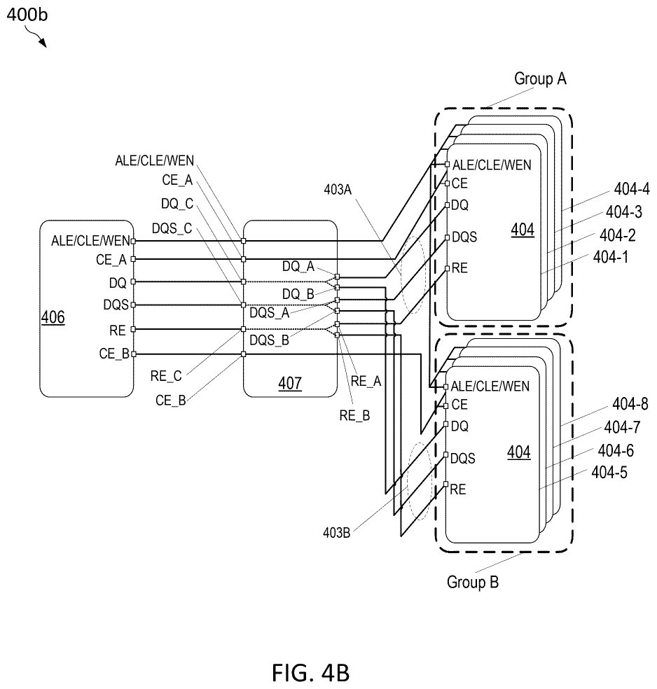

FIGS. 4A-4B illustrate example memory systems. FIG. 4A illustrates an example memory system 400a that includes a memory controller 406 and memory devices 404 (e.g., memory devices 404-1, 404-2, . . . , 404-8). In some implementations, the memory devices 404 can be divided into multiple groups (e.g., group A and group B as shown in FIG. 4A). For example, group A can include memory devices 404-1 to 404-4, and group B can include memory devices 404-5 to 404-8. Each memory device 404 can be a three-dimensional (3D) memory device (e.g., 3D NAND memory) illustrated in FIGS. 1-3. The memory controller 406 is coupled to the memory devices 404. The memory controller 406 can include control pins and data pins. In some implementations, the control pins of the memory controller 406 can include an address latch enable (ALE) pin, a command latch enable (CLE) pin, and a write enable (WEN) pin. The control pins of the memory controller 406 can also include one or more chip enable (CE) pins for group A (referred to as CE_A) and one or more chip enable pins for group B (referred to as CE_B). The data pins of the memory controller 406 can include input/output data (DQ) pins, one or more data clock pins (also referred to as DQ strobe (DQS) pins), and one or more read enable (RE) pins. In some implementations, each memory device 404 can also include an ALE pin, a CLE pin, and a WEN pin, a CE pin, DQ pins, DQS pins, and RE pins. The CE_A pins of the memory controller 406 can be coupled to the CE pins of the memory devices 404 in group A (e.g., memory devices 404-1 to 404-4). The CE_B pins of the memory controller 406 can be coupled to the CE pins of the memory devices 404 in group B (e.g., memory devices 404-5 to 404-8). The DQ pins of the memory controller 406 are coupled to both the DQ pins of the memory devices 404 in group A and the DQ pins of the memory devices 404 in group B. Similarly, the DQS pins of the memory controller 406 are coupled to both the DQS pins of the memory devices 404 in group A and the DQS pins of the memory devices 404 in group B, and the RE pins of the memory controller 406 are coupled to both the RE pins of the memory devices 404 in group A and the RE pins of the memory devices 404 in group B. In some implementations, memory devices from both group A and group B are coupled to the memory controller 406 at the same time, even though the memory controller 406 only communicates with a memory device from one group. This may increase a load and a parasitic capacitance on the data path of the memory system 400a and thus decrease the memory data transmission bandwidth.

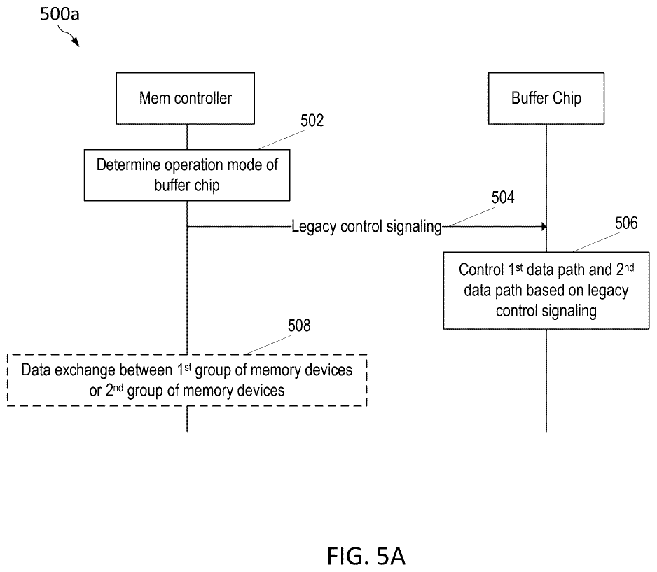

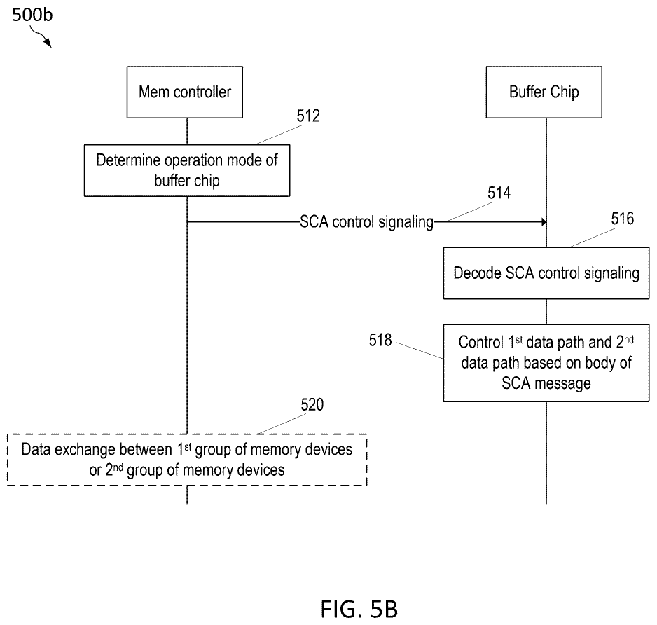

FIG. 4B illustrates an example memory system 400b that includes a memory controller 406, a buffer chip 407, and memory devices 404 (e.g., memory devices 404-1, 404-2, . . . , 404-8). In some implementations, the memory devices 404 can be divided into multiple groups (e.g., group A and group B as shown in FIG. 4B). For example, group A can include memory devices 404-1 to 404-4, and group B can include memory devices 404-5 to 404-8. Each memory device 404 can be a 3D memory device (e.g., 3D NAND memory) illustrated in FIGS. 1-3. The memory controller 406 is coupled to the buffer chip 407 and the memory devices 404. The memory controller 406 can include control pins and data pins. In some implementations, the control pins of the memory controller 406 can include an ALE pin, a CLE pin, and a WEN pin. The control pins of the memory controller 406 can also include one or more CE pins for group A (referred to as CE_A) and one or more CE pins for group B (referred to as CE_B). The data pins of the memory controller 406 can include DQ pins, one or more DQS pins, and one or more RE pins. The control pins of the memory controller 406 can be configured to transmit control signaling to the buffer chip 407, the memory devices 404-1 to 404-4 in group A, and the memory devices 404-5 to 404-8 in group B. For example, as described below with reference to FIGS. 5A-5B, the control signaling can include CE signals from CE_A and CE_B pins of the memory controller 406, a CLE signal from CLE pin of the memory controller 406, and an ALE signal from the ALE pin of the memory controller 406. The data pins of the memory controller 406 can be configured to communicate a data signal with the memory devices 404-1 to 404-4 in group A (e.g., through data path 403A as described below) and the memory devices 404-5 to 404-8 in group B (e.g., through data path 403B as described below). In some implementations, each memory device 404 can also include an ALE pin, a CLE pin, and a WEN pin, a CE pin, DQ pins, DQS pins, and RE pins. In some implementations, the buffer chip 407 can include an ALE pin, a CLE pin, and a WEN pin. The ALE pin, the CLE pin, and the WEN pin of the buffer chip 407 can be coupled to (e.g., through a conductive wire) the ALE pin, the CLE pin, and the WEN pin of the memory controller 406 and the ALE pin, the CLE pin, and the WEN pin of each memory device 404. The buffer chip 407 can include one or more CE pins for group A (referred to as CE_A) and one or more CE pins for group B (referred to as CE_B). The CE_A pins of the buffer chip 407 can be coupled to the CE_A pins of the memory controller 406 and the CE pins of the memory devices 404 in group A (e.g., memory devices 404-1 to 404-4). The CE_B pins of the buffer chip 407 can be coupled to the CE_B pins of the memory controller 406 and the CE pins of the memory devices 404 in group B (e.g., memory devices 404-5 to 404-8). The buffer chip 407 can include DQ pins (e.g., DQ_A, DQ_B, and DQ_C). The DQ_A pins are coupled to the DQ pins of the memory devices 404 in group A, and the DQ_B pins are coupled to the DQ pins of the memory devices 404 in group B. The DQ_C pins are coupled to the DQ pins of the memory controller 406. The buffer chip 407 can include DQS pins (e.g., DQS_A, DQS_B, and DQS_C). The DQS_A pins are coupled to the DQS pins of the memory devices 404 in group A, and the DQS_B pins are coupled to the DQS pins of the memory devices 404 in group B. The DQS_C pins are coupled to the DQS pins of the memory controller 406. The buffer chip 407 can include RE pins (e.g., RE_A, RE_B, and RE_C). The RE_A pins are coupled to the RE pins of the memory devices 404 in group A, and the RE_B pins are coupled to the RE pins of the memory devices 404 in group B. The RE_C pins are coupled to the RE pins of the memory controller 406.

A data path 403A can be formed between the data pins (e.g., DQ_A pins, DQS_A pins, and RE_A pins) of the buffer chip 407 and the data pins of the memory devices 404-1 to 404-4 in group A. In other words, the data path 403A can be coupled between the buffer chip 407 and the memory devices in group A. For example, the data path 403A can include connections (e.g., conductive wires) between the DQ_A pins and the DQ pins of the memory devices in group A, connections between the DQS_A pins and the DQS pins of the memory devices in group A, and connections between the RE_A pins and the RE pins of the memory devices in group A. Similarly, a data path 403B can be formed between the data pins (e.g., DQ_B pins, DQS_B pins, and RE_B pins) of the buffer chip 407 and the data pins of the memory devices 404-5 to 404-8 in group B. In other words, the data path 403B can be coupled between the buffer chip 407 and the memory devices in group B. For example, the data path 403B can include connections (e.g., conductive wires) between the DQ_B pins and the DQ pins of the memory devices in group B, connections between the DQS_B pins and the DQS pins of the memory devices in group B, and connections between the RE_B pins and the RE pins of the memory devices in group B.

The memory controller 406 can be configured to perform read, write, and erase operations on the memory devices 404 by exchanging signals with the buffer chip 407, the memory devices in group A, and the memory devices in group B. In some implementations, the buffer chip 407 is configured to control the data path 403A and the data path 403B based on control signaling the buffer chip 407 received from the memory controller 406. For example, when the memory controller 406 communicates with a memory device in group A, the buffer chip 407 can turn on the data path 403A and turn off the data path 403B. When the memory controller 406 communicates with a memory device in group B, the buffer chip 407 can turn on the data path 403B and turn off the data path 403A. In this way, fewer memory devices are coupled to the memory controller 406 at the same time, thereby reducing a load and a parasitic capacitance on the data path of the memory system 400b and increasing the memory data transmission bandwidth.

In some implementations, memory devices in both the group A and the group B are required (for example, during an impedance matching operation of the memory system 400b), and the buffer chip 407 can also be configured to turn on both the data path 403A and the data path 403B for such operations.

It is understood that the examples in FIGS. 4A-4B are for illustration purpose and should not be construed in a limiting sense. While FIGS. 4A-4B show two groups of memory devices and that each group includes four memory devices, in practice, any suitable number of memory device groups can be coupled to a memory controller and a buffer chip in a memory system, and each memory device group can include any suitable number of memory devices.

In some implementations, a buffer chip (e.g., the buffer chip 407 as shown in FIG. 4B) can be configured to operate in multiple operation modes. The multiple operation modes can include a legacy mode and a separate command address (SCA) mode. The buffer chip can switch between the multiple operation modes based on a control signal from a memory controller (e.g., the memory controller 406 as shown in FIG. 4B). The buffer chip can include an SCA enable (SCAEN) pin (not shown in FIG. 4B) configured to indicate an operation mode of the buffer chip. For example, a higher level voltage on the SCAEN pin can indicate that the buffer chip is operating in the SCA mode, and a lower level voltage on the SCAEN pin can indicate that the buffer chip is operating in the legacy mode, or vice versa. In some implementations, the buffer chip can be configured to receive the control signal through the SCAEN pin and switch the operation mode based on the control signal. For example, the buffer chip can switch to the SCA mode when the control signal from the SCAEN pin is at a higher level voltage and switch to the legacy mode when the control signal from the SCAEN pin is at a lower level voltage, or vice versa.

FIG. 5A includes a flow chart 500a, which illustrates example operations of a memory controller and a buffer chip when the buffer chip is operating in the legacy mode. The memory controller can be an example of the memory controller 406 of FIG. 4B, and the buffer chip can be an example of the buffer chip 407 of FIG. 4B.

As shown in the flow chart 500a, at 502, the memory controller can determine an operation mode of the buffer chip (for example, by checking a SCAEN pin of buffer chip). At 504, when the memory controller determines that the buffer chip is operating in the legacy mode, the memory controller can transmit legacy control signaling to the buffer chip. In some implementations, the legacy control signaling can include control signals transmitted from CE_A pins and CE_B pins (e.g., as shown in FIG. 4B) of the memory controller. The memory controller can select at least one of group A or group B by transmitting the legacy control signals. For example, when the memory controller determines to exchange data between the memory devices in group A, the memory controller can transmit chip enable signals (e.g., from CE_A pins of the memory controller) to the buffer chip (e.g., through CE_A pins of the buffer chip) and the memory devices in group A (e.g., through CE pins of memory devices 404-1 to 404-4). On the other hand, when the memory controller determines to exchange data between the memory devices in group B, the memory controller can transmit chip enable signals (e.g., from CE_B pins of the memory controller) to the buffer chip (e.g., through CE_B pins of the buffer chip) and the memory devices in group B (e.g., through CE pins of memory devices 404-5 to 404-8). In some implementations, the chip enable signal is a lower level voltage, which indicates an instruction to enable a memory device. On the other hand, a higher level voltage in the chip enable signal indicates an instruction to disable the memory device. At 506, the buffer chip can control data paths (e.g., data path 403A and data path 403B as shown in FIG. 4B) between the buffer chip and group A or group B based on the legacy control signaling received from the memory controller. For example, the buffer chip can turn on the data path 403A when chip enable signals of lower level voltages are received from the CE_A pins of the buffer chip, and turn off the data path 403A when chip enable signals of higher level voltages are received from the CE_A pins of the buffer chip. Similarly, the buffer chip can turn on the data path 403B when chip enable signals of lower level voltages are received from the CE_B pins of the buffer chip, and turn off the data path 403B when chip enable signals of higher level voltages are received from the CE_B pins of the buffer chip. In some implementations, at 508, the memory controller can exchange data between the selected group of memory devices through the buffer chip and the corresponding data path.

FIG. 5B includes a flow chart 500b, which illustrates example operations of a memory controller and a buffer chip when the buffer chip is operating in the SCA mode. The memory controller can be an example of the memory controller 406 of FIG. 4B, and the buffer chip can be an example of the buffer chip 407 of FIG. 4B.

As shown in the flow chart 500b, at 512, the memory controller can determine an operation mode of the buffer chip (for example, by checking a SCAEN pin of buffer chip). At 514, when the memory controller determines that the buffer chip is operating in the SCA mode, the memory controller can transmit SCA control signaling to the buffer chip. In some implementations, the SCA control signaling can include control signals transmitted from ALE, CLE, and WEN pins (e.g., as shown in FIG. 4B) of the memory controller. The memory controller can select at least one of group A or group B by transmitting the SCA control signals. In some implementations, the SCA control signals include commands (also referred to as command address (CA) commands) carried using a CLE signal (e.g., from the CLE pin of the memory controller), an ALE signal (e.g., from the ALE pin of the memory controller), and a WEN signal (e.g., from the WEN pin of the memory controller).

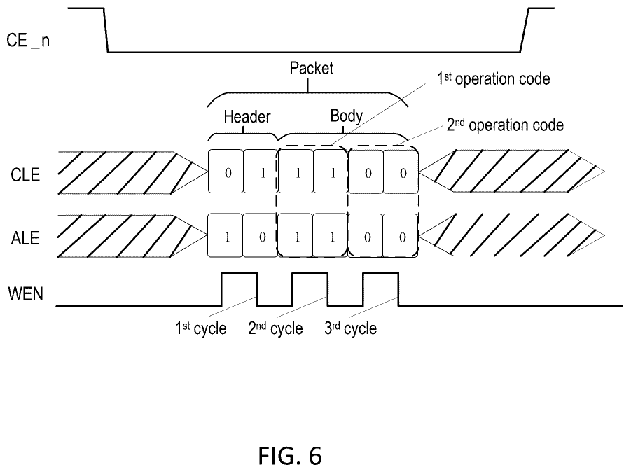

At 516, the buffer chip can decode the SCA control signaling (e.g., CA command) received from the memory controller. In some implementations, CA commands defined in the Joint Electron Device Engineering Council (JEDEC) standards can be used. FIG. 6 illustrates an example decoding process of CA commands. The decoding process can be performed by the buffer chip. As shown in FIG. 6, the buffer chip can receive a CE signal, a CLE signal, an ALE signal, and an WEN signal from the memory controller. In some implementations, the buffer chip can perform the decoding of CA commands when the CE signal is at a lower level (e.g., a lower level voltage), which indicates enabling of a memory device. A CA command or packet can include a header and a body. In some implementations, the header includes four bits, and the body includes eight bits. The header can be determined based on voltage levels of the CLE signal and the ALE signal at a rising edge and a falling edge of the first clock cycle of the WEN signal. For example, the first bit of the header is determined by the ALE signal at the rising edge, the second bit of the header is determined by the CLE signal at the rising edge, the third bit of the header is determined by the ALE signal at the falling edge, and the fourth bit of the header is determined by the CLE signal at the falling edge. Similarly, the body can be determined based on the voltage levels of the CLE signal and the ALE signal at rising edges and falling edges of the second clock cycle and the third clock cycle of the WEN signal. In some implementations, the first four bits of the body can be a first operation code, and the last four bits of the body can be a second operation code. The buffer chip can perform different operations based on the first operation code and the second operation code.

Table I is an example SCA header definition table. In some instances, reserved CA command types (e.g., “Header 4′b1001” in Table I) in the JEDEC standards can be used to instruct the buffer chip to control the data path. In this way, memory devices whose ALE, CLE, and WEN pins are coupled to the memory controller will not respond to the ALE, CLE, and WEN signals they receive from the memory controller.

TABLE I

| Header rising edge | | Header falling edge | | | |
|---|---|---|---|---|---|
| CA[1] | CA[0] | CA[1] | CA[0] | | |
| h[1] | h[0] | h[3] | h[2] | CA packet | CA packet |
| CLE | ALE | CLE | ALE | type | structure |
| 0 | 0 | 0 | 0 | CA data | Output |
| | | | | output | |
| 0 | 0 | 0 | 1 | VSP | VSP |
| 0 | 0 | 1 | 0 | CA data | Input |
| | | | | input | |
| 0 | 0 | 1 | 1 | VSP | VSP |
| 0 | 1 | 0 | 0 | Address | Input |
| 0 | 1 | 0 | 1 | Reserved | Reserved |
| 0 | 1 | 1 | 0 | Reserved | Reserved |
| 0 | 1 | 1 | 1 | Reserved | Reserved |

At 518, the buffer chip can control data paths (e.g., data path 403A and data path 403B as shown in FIG. 4B) between the buffer chip and group A or group B based on the SCA control signaling received from the memory controller. In some implementations, the buffer chip can first check the header of the CA command to determine if the header indicates a predetermined type. For example, if the buffer chip determines that the header's content is 4′b1001, the buffer chip recognizes that it can control data paths based on the body of the CA command. The buffer chip can perform operations based on the first operation code and the second operation code of the body of the CA command. In some implementations, the first operation code can be defined as an operation type, and the second operation code can be defined as a specific operation command. For example, the first operation code being 4′b 1110 indicates a test mode, and corresponding second operation code can indicate a specific voltage value the buffer chip can set for a pin for the test mode. In another example, the first operation code being 4′b1111 can indicate the buffer chip to control the data paths between different groups of memory devices (e.g., group switch). Correspondingly, at this time, the second operation code can indicate the buffer chip to turn on or off a data path. For example, the second operation code being 4′b0000 can indicate the buffer chip to turn off both the data path 403A and the data path 403B; the second operation code being 4′b0001 can indicate the buffer chip to turn on the data path 403A and turn off the data path 403B; the second operation code being 4′b0010 can indicate the buffer chip to turn off the data path 403A and turn on the data path 403B; and the second operation code being 4′b0011 can indicate the buffer chip to turn on both the data path 403A and the data path 403B.

In some implementations, at 520, the memory controller can exchange data between the selected group of memory devices through the buffer chip and the corresponding data path.

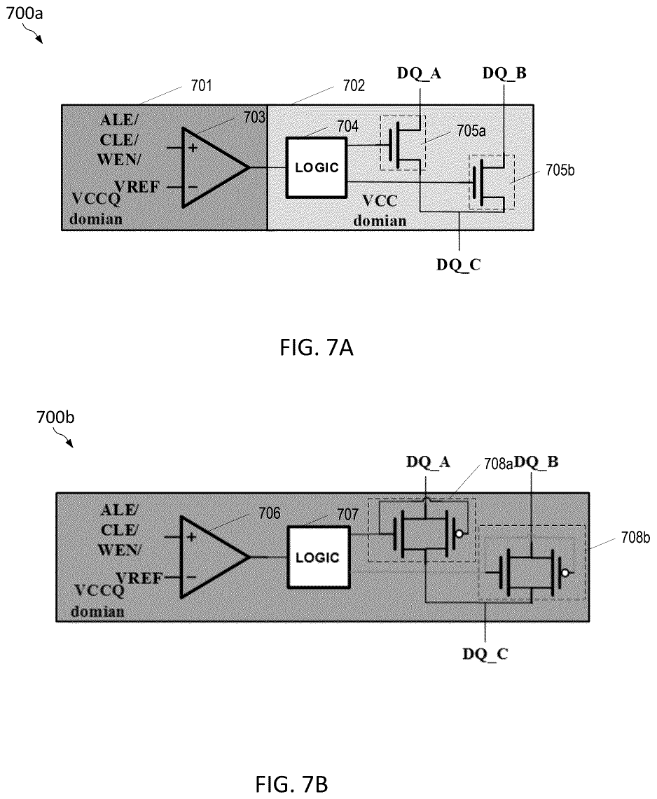

In some implementations, a data path between the buffer chip and a memory device includes electrical connections between pins (e.g., DQ_A, DQ_B, DQS_A, DQS_B, RE_A, and RE_B as shown in FIG. 4B) of the buffer chip and pins (e.g., DQ, DQS, and RE as shown in FIG. 4B) of the memory device. The buffer chip can turn on (e.g., enabling) and off (e.g., disabling) the data path (e.g., at 506 of FIG. 5A or 518 of FIG. 5B) by switching on and off the electrical connections in the data path between the buffer chip and the memory device. Detailed operations of the buffer chip are described further with reference to FIGS. 7A and 7B.

In some implementations, the buffer chip is a passive chip. When the memory controller exchanges data between the selected group of memory devices through the buffer chip and the corresponding data path, the buffer chip can forward data signals between the memory controller and the selected group of memory devices without shaping or reshaping the data signals. For example, the buffer chip is configured to receive a first data signal from the memory controller and forward the first data signal to the data path 403A or the data path 403B without reshaping the first data signal. Similarly, the buffer chip is further configured to receive a second data signal from the data path 403A or the data path 403B and forward the second data signal back to the memory controller without reshaping the second data signal. The forwarding process is carried out without reshaping or shaping the first data signal or the second data signal, thereby ensuring that the transmitted data signal retains its original characteristics as determined by the memory controller or the memory devices. By omitting the signal shaping function typically found in active chips, the passive buffer chip can reduce overall power consumption and thermal output of the memory system. Furthermore, this design can eliminate the need for additional circuitry associated with signal processing (e.g., for signal shaping, encoding, decoding, or time synchronization), thereby reducing manufacturing costs and improving the scalability of the memory system for high-density applications.

FIGS. 7A-7B illustrate example buffer chips. An example buffer chip 700a in FIG. 7A includes a circuit 701 and a circuit 702. The circuit 701 can be coupled to control pins of the buffer chip, such as ALE, CLE, WEN, CE_A, and CE_B pins of the buffer chip 407 of FIG. 4B. The circuit 701 can be configured to receive control signals from the memory controller and convert the control signals to digital values. For example, as shown in FIG. 7A, the circuit 701 can include one or more comparator circuits 703. Each comparator circuit 703 can be configured to compare a control signal (e.g., an ALE signal, a CLE signal, a WEN signal, a CE_A signal or a CE_B signal) with a reference value (e.g., Vref as shown in FIG. 7A) to determine a digital value (e.g., binary 0 or 1) carried by the control signal. The circuit 702 can include a logic circuit 704 and multiple switches 705 (e.g., switches 705a and 705b as shown in FIG. 7A). The circuit 702 can be coupled to data pins of the buffer chip, such as DQ_A, DQ_B, DQ_C, DQS_A, DQS_B, DQS_C, RE_A, RE_B, and RE_C pins of the buffer chip 407 of FIG. 4B. The logic circuit 704 of the circuit 702 can receive outputs of the circuit 701 (e.g., digital values of the control signals), determine an operation based on the control signals, and output voltages to control the switches 705. For example, switch 705a is coupled between a DQ_C pin (which is coupled to the memory controller) and a DQ_A pin (which is coupled to a DQ pin of a memory device in group A). Switch 705b is coupled between the DQ_C pin and a DQ_B pin (which is coupled to a DQ pin of a memory device in group B). If the logic circuit 704 determines that group A is selected based on the control signal received by the circuit 701, the logic circuit 704 can turn on the switch 705a to enable the electrical connection between the DQ_C pin and the DQ_A pin, so that one connection in the data path 403A is enabled. If the logic circuit 704 determines that group A is not selected based on the control signal received by the circuit 701, the logic circuit 704 can turn off the switch 705a to disable the electrical connection between the DQ_C pin and the DQ_A pin, so that one connection in the data path 403A is disabled. Similarly, the logic circuit 704 can turn on or off the switch 705b to disable a connection in the data path 403B based on the control signal. As shown in FIG. 7A, each of the switches 705a and 705b can be implemented using an N-type metal-oxide-semiconductor field-effect transistor (MOSFET).

In some implementations, the circuit 701 and the circuit 702 can be configured to operate in different voltage domains. For example, the circuit 701 can operate in a power domain that supply power to output transistors (e.g., VCCQ domain) for typical 1.2 volt (V) applications. The circuit 702 can operate in a power domain for power supply of 2.5 V (e.g., VCC domain). For example, the buffer chip 700a can be manufactured using fully depleted silicon-on-insulator (FDSOI) techniques, which can integrate high voltage transistors and low voltage transistors in a same semiconductor structure without significant process adjustment.

An example buffer chip 700b in FIG. 7B includes one or more comparator circuits 706, a logic circuit 707, and switches 708 (e.g., 708a and 708b). Similar to what is described with reference to FIG. 7A, Each comparator circuit 706 can be configured to compare a control signal (e.g., an ALE signal, a CLE signal, a WEN signal, a CE_A signal or a CE_B signal) with a reference value to determine a digital value (e.g., binary 0 or 1) carried by the control signal. The logic circuit 707 can receive outputs of the comparator circuit 706 (e.g., digital values of the control signals), determine an operation based on the control signals, and output voltages to control the switches 708. Different from the buffer chip 700a of FIG. 7A, the comparator circuits 706, the logic circuit 707, and the switches 708 of the buffer chip 700b can operate in the same power domain (e.g., VCCQ domain). In some implementations, as shown in FIG. 7B, each of the switches 708a and 708b can be implemented as a combination of an N-type MOSFET and a P-type MOSFET.

It is understood that the two switches in FIG. 7A or 7B are for illustration purpose and are not intended to be construed in a limiting sense. In practice, the buffer chip can include more than two switches. For example, the buffer chip can include a first group of switches coupled between a first group of data pins (e.g., DQ_A, DQS_A, RE_A pins) of the buffer chip and a third group of data pins (e.g., DQ_C, DQS_C, RE_C) of the buffer chip. Each switch in the first group of switches can be coupled between a data pin (e.g., a DQS_A) in the first group and a corresponding data pin (e.g., a DQS_C pin) in the third group. The buffer chip can further include a second group of switches coupled between a second group of data pins (e.g., DQ_B, DQS_B, RE_B pins) of the buffer chip and the third group of data pins (e.g., DQ_C, DQS_C, RE_C) of the buffer chip. Each switch in the second group of switches can be coupled between a data pin (e.g., a DQS_B) in the second group and a corresponding data pin (e.g., a DQS_C pin) in the third group.

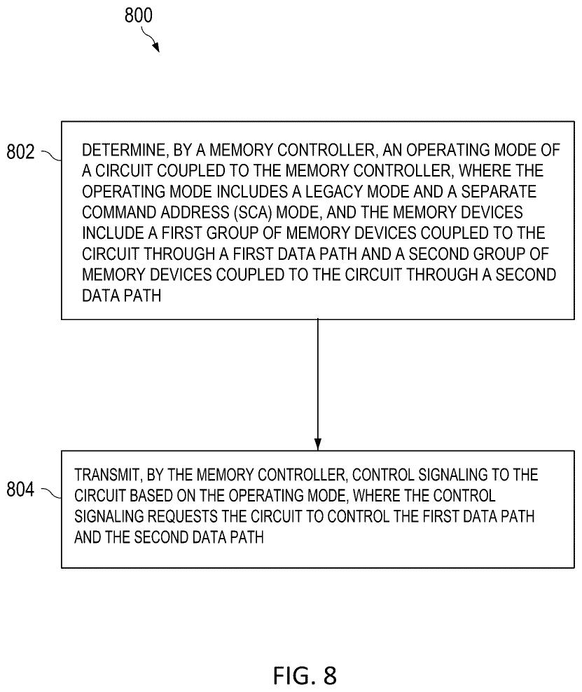

FIG. 8 illustrates a flowchart of an example method 800 performed by a memory controller disclosed herein (e.g., the memory controller 406 of FIG. 4B). The memory controller can be included in a memory system. The memory system can further include a buffer chip (e.g., the buffer chip 407 of FIG. 4B) and memory devices (e.g., the memory devices 404 of FIG. 4B).

As shown in FIG. 8, at 802, the memory controller can determine an operating mode of the buffer chip of the memory system. The buffer chip is coupled to the memory controller and the memory devices of the memory system. The operating mode includes a legacy mode and an SCA mode. The memory devices include a first group of memory devices (e.g., group A of FIG. 4B) coupled to the buffer chip through a first data path (e.g., data path 403A) and a second group of memory devices (e.g., group B of FIG. 4B) coupled to the buffer chip through a second data path (e.g., data path 403B).

At 804, the memory controller can transmit control signaling to the buffer chip based on the operating mode, e.g., as described at 504 and 514 with reference to FIGS. 5A and 5B. The control signaling requests the buffer chip to control the first data path and the second data path.

In some implementations, e.g., as described with reference to 504 of FIG. 5A, in response to determining that the operating mode is the legacy mode, the memory controller transmits a first chip enable signal from a first chip enable pin (e.g., CE_A pin) of the memory controller and a second chip enable signal from a second chip enable pin (e.g., CE_B pin) of the memory controller. The first chip enable signal indicates the buffer chip to enable or disable the first group of memory devices, and the second chip enable signal indicates the buffer chip to enable or disable the second group of memory devices.

In some implementations, e.g., as described with reference to 514 of FIG. 5B, in response to determining that the operating mode is the SCA mode, the memory controller transmits an SCA message (e.g., CA command) using a command latch enable signal and an address latch enable signal. The SCA message comprises a header and a body (e.g., as described with reference to Table I and FIG. 6), the header indicates an SCA message type, and the body indicates the buffer chip to perform one of the following operations: disabling the first data path and the second data path; enabling the first data path and disabling the second data path; disabling the first data path and enabling the second data path; or enabling the first data path and the second data path.

In some implementations, the command latch enable signal is transmitted from a command latch enable pin (e.g., CLE pin) of the memory controller, and the address latch enable signal is transmitted from an address latch enable pin (e.g., ALE pin) of the memory controller.

In some implementations, determining the operating mode of the buffer chip includes determining the operating mode of the buffer chip based on a voltage level at a status pin (e.g., the SCAEN pin) of the buffer chip.

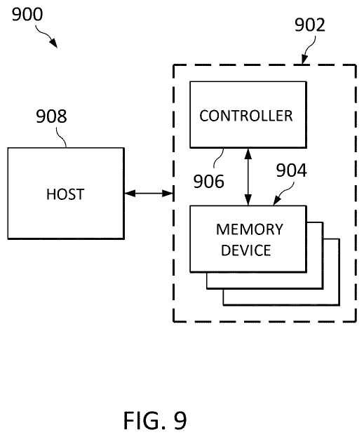

FIG. 9 illustrates an example of a block diagram of system 900 having a memory device, according to some aspects of the present disclosure. System 900 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 9, system 900 can include a host 908 and a memory system 902 having one or more memory devices 904 and a memory controller 906. Host 908 can be a processor of an electronic device, such as a central processing unit (CPU), or a system-on-chip (SoC), such as an application processor (AP). Host 908 can be configured to send or receive data to or from memory devices 904.

Memory device 904 can be any memory device disclosed in the present disclosure, such as the memory device 100 of FIG. 1 and the memory devices 404 of FIGS. 4A-4B. Memory controller 906 is coupled to memory device 904 and host 908 and is configured to control memory device 904, according to some implementations. Memory controller 906 can manage the data stored in memory device 904 and communicate with host 908. In some implementations, memory controller 906 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 906 is designed for operating in a high duty-cycle environment SSDs or embedded multi-media-cards (eMMCs) used as data storage for mobile devices, such as smartphones, tablets, laptop computers, etc., and enterprise storage arrays. Memory controller 906 can be configured to control operations of memory device 904, such as read, erase, and program operations. Memory controller 906 can also be configured to manage various functions with respect to the data stored or to be stored in memory device 904 including, but not limited to bad-block management, garbage collection, logical-to-physical address conversion, wear leveling, etc. In some implementations, memory controller 906 is further configured to process error correction codes (ECCs) with respect to the data read from or written to memory device 904. Any other suitable functions may be performed by memory controller 906 as well, for example, formatting memory device 904.

Memory controller 906 can communicate with an external device (e.g., host 908) according to a particular communication protocol. For example, memory controller 906 may communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

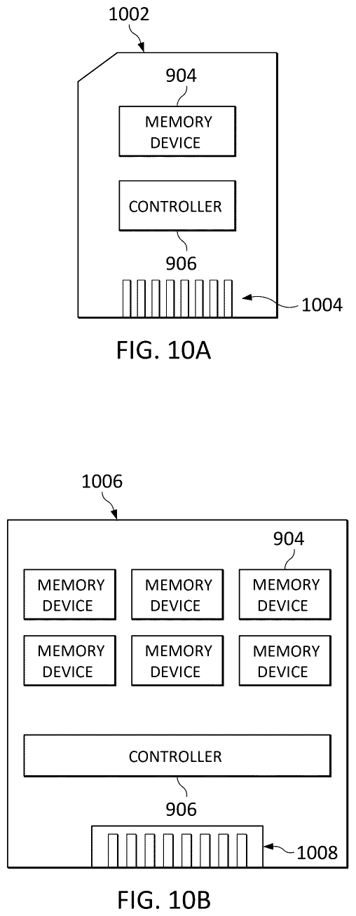

Memory controller 906 and one or more memory devices 904 can be integrated into various types of storage devices, for example, be included in the same package, such as a universal Flash storage (UFS) package or an eMMC package. That is, memory system 902 can be implemented and packaged into different types of end electronic products. In one example as shown in FIG. 10A, memory controller 906 and a single memory device 904 may be integrated into a memory card 1002. Memory card 1002 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. Memory card 1002 can further include a memory card connector 1004 coupling memory card 1002 with a host (e.g., host 908 in FIG. 9). In another example as shown in FIG. 10B, memory controller 906 and multiple memory devices 904 may be integrated into an SSD 1006. SSD 1006 can further include an SSD connector 1008 coupling SSD 1006 with a host (e.g., host 908 in FIG. 9). In some implementations, the storage capacity and/or the operation speed of SSD 1006 is greater than those of memory card 1002.

Implementations of the subject matter and the actions and operations described in this present disclosure can be implemented in digital electronic circuitry, in tangibly-embodied computer software or firmware, in computer hardware, including the structures disclosed in this present disclosure and their structural equivalents, or in combinations of one or more of them. Implementations of the subject matter described in this present disclosure can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively, or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

It is noted that references in the present disclosure to “one embodiment,” “an embodiment,” “an example embodiment,” “some implementations,” “some implementations,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to affect such feature, structure or characteristic in connection with other implementations whether or not explicitly described.

In general, terminology can be understood at least in part from usage in context. For example, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and may, instead, allow for existence of additional factors not necessarily expressly described, again, depending at least in part on context.

It should be readily understood that the meaning of “on,” “above,” and “over” in the present disclosure should be interpreted in the broadest manner such that “on” not only means “directly on” something, but also includes the meaning of “on” something with an intermediate feature or a layer therebetween. Moreover, “above” or “over” not only means “above” or “over” something, but can also include the meaning it is “above” or “over” something with no intermediate feature or layer therebetween (i.e., directly on something).

Further, spatially relative terms, such as “beneath,” “below,” “lower,” “above,” “upper,” and the like, can be used herein for ease of description to describe one element or feature's relationship to another element(s) or feature(s) as illustrated in the figures. The spatially relative terms are intended to encompass different orientations of the device in use or process step in addition to the orientation depicted in the figures. The apparatus can be otherwise oriented (rotated 90 degrees or at other orientations) and the spatially relative descriptors used herein can likewise be interpreted accordingly.

As used herein, the term “substrate” refers to a material onto which subsequent material layers are added. The substrate includes a “top” surface and a “bottom” surface. The top surface of the substrate is typically where a semiconductor device is formed, and therefore the semiconductor device is formed at a top side of the substrate unless stated otherwise. The bottom surface is opposite to the top surface and therefore a bottom side of the substrate is opposite to the top side of the substrate. The substrate itself can be patterned. Materials added on top of the substrate can be patterned or can remain unpatterned. Furthermore, the substrate can include a wide array of semiconductor materials, such as silicon, germanium, gallium arsenide, indium phosphide, etc. Alternatively, the substrate can be made from an electrically noN+ conductive material, such as a glass, a plastic, or a sapphire wafer.

As used herein, the term “layer” refers to a material portion including a region with a thickness. A layer has a top side and a bottom side where the bottom side of the layer is relatively close to the substrate and the top side is relatively away from the substrate. A layer can extend over the entirety of an underlying or overlying structure, or can have an extent less than the extent of an underlying or overlying structure. Further, a layer can be a region of a homogeneous or inhomogeneous continuous structure that has a thickness less than the thickness of the continuous structure. For example, a layer can be located between any set of horizontal planes between, or at, a top surface and a bottom surface of the continuous structure. A layer can extend horizontally, vertically, and/or along a tapered surface. A substrate can be a layer, can include one or more layers therein, and/or can have one or more layer thereupon, thereabove, and/or therebelow. A layer can include multiple layers. For example, an interconnect layer can include one or more conductive and contact layers (in which contacts, interconnect lines, and/or vertical interconnect accesses (VIAs) are formed) and one or more dielectric layers.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances. As used herein, the term “about” indicates the value of a given quantity that can vary based on a particular technology node associated with the subject semiconductor device. Based on the particular technology node, the term “about” can indicate a value of a given quantity that varies within, for example, 10-30% of the value (e.g., .+−0.10%, .+−0.20%, or .+−0.30% of the value).

In the present disclosure, the term “horizontal/horizontally/lateral/laterally” means nominally parallel to a lateral surface of a substrate, and the term “vertical” or “vertically” means nominally perpendicular to the lateral surface of a substrate.

As used herein, the term “3D memory” refers to a three-dimensional (3D) semiconductor device with vertically oriented strings of memory cell transistors (referred to herein as “memory strings,” such as NAND strings) on a laterally-oriented substrate so that the memory strings extend in the vertical direction with respect to the substrate.

The present disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include implementations in which the first and second features may be in direct contact, and may also include implementations in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various implementations and/or configurations discussed.

The foregoing description of the specific implementations can be readily modified and/or adapted for various applications. Therefore, such adaptations and modifications are intended to be within the meaning and range of equivalents of the disclosed implementations, based on the teaching and guidance presented herein.

While the present disclosure contains many specific implementation details, these should not be construed as limitations on the scope of what is being claimed, which is defined by the claims themselves, but rather as descriptions of features that may be specific to particular implementations of particular inventions. Certain features that are described in this present disclosure in the context of separate implementations can also be implemented in combination in a single implementation. Conversely, various features that are described in the context of a single embodiment can also be implemented in multiple implementations separately or in any suitable sub-combination. Moreover, although features may be described above as acting in certain combinations and even initially be claimed as such, one or more features from a claimed combination can in some cases be excised from the combination, and the claim may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations also are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

The breadth and scope of the present disclosure should not be limited by any of the above-described exemplary implementations, but should be defined only in accordance with the following claims and their equivalents.

What is claimed is:

1. A memory system, comprising:
a memory controller;
a buffer chip coupled to the memory controller;
a first group of memory devices, wherein a first data path is coupled between the buffer chip and the first group of memory devices; and
a second group of memory devices, wherein a second data path is coupled between the buffer chip and the second group of memory devices, and the buffer chip is configured to control the first data path and the second data path based on control signaling received from the memory controller.

2. The memory system of claim 1, wherein the buffer chip is configured to receive a first data signal from the memory controller and forward the first data signal to the first data path or the second data path without shaping the first data signal, and receive a second data signal from the first data path or the second data path and forward the second data signal to the memory controller without shaping the second data signal.

3. The memory system of claim 1, wherein the buffer chip comprises a first group of data pins coupled to the first group of memory devices through the first data path, and a second group of data pins coupled to the second group of memory devices through the second data path, and the buffer chip is configured to forward a data signal from the memory controller to the first data path through the first group of data pins or to the second data path through the second group of data pins.

4. The memory system of claim 3, wherein the buffer chip further comprises a third group of data pins, first control pins, and second control pins, and wherein the third group of data pins, the first control pins, and the second control pins are coupled to the memory controller.

5. The memory system of claim 4, wherein the first control pins comprise a first chip enable pin coupled to the memory controller and the first group of memory devices, and a second chip enable pin coupled to the memory controller and the second group of memory devices, the second control pins comprise a command latch enable pin and an address latch enable pin, and the command latch enable pin and the address latch enable pin are coupled to the memory controller, the first group of memory devices, and the second group of memory devices.

6. The memory system of claim 5, wherein the buffer chip is configured to switch between a legacy mode and a separate command address (SCA) mode based on a control signal from the memory controller.

7. The memory system of claim 6, wherein the buffer chip is in the legacy mode, and the control signaling includes a first chip enable signal and a second chip enable signal received from the memory controller through the first chip enable pin and the second chip enable pin respectively.

8. The memory system of claim 6, wherein the buffer chip is in the SCA mode, the control signaling includes a command latch enable signal and an address latch enable signal received from the memory controller through the command latch enable pin and the address latch enable pin respectively, and the buffer chip is configured to determine an SCA message based on at least the command latch enable signal, the address latch enable signal, and an SCA protocol.

9. The memory system of claim 8, wherein the SCA message comprises a header and a body, and in response to determining that the header indicates a predetermined SCA message type, the buffer chip is configured to perform one of the following operations based on the body:
disabling the first data path and the second data path;
enabling the first data path and disabling the second data path;
disabling the first data path and enabling the second data path; or
enabling the first data path and the second data path.

10. The memory system of claim 4, wherein the buffer chip comprises:
a first circuit coupled to the first control pins and the second control pins; and
a second circuit coupled to the first group of data pins, the second group of data pins, and the third group of data pins, wherein the first circuit is configured to operate in a first voltage domain, and the second circuit is configured to operate in a second voltage domain.

11. The memory system of claim 10, wherein the second circuit comprises:
a first group of switches coupled between the first group of data pins and the third group of data pins; and
a second group of switches coupled between the second group of data pins and the third group of data pins.

12. The memory system of claim 1, wherein the first group of memory devices comprises four memory devices, and the second group of memory devices comprises four memory devices.

13. A memory controller, comprising first control pins, second control pins, and data pins, wherein:
the first control pins are configured to transmit first control signaling to a buffer chip, a first group of memory devices, and a second group of memory devices;
the second control pins are configured to transmit second control signaling to the buffer chip, the first group of memory devices, and the second group of memory devices; and
the data pins are configured to communicate a data signal with the first group of memory devices through a first data path between the buffer chip and the first group of memory devices or with the second group of memory devices through a second data path between the buffer chip and the second group of memory device.

14. The memory controller of claim 13, wherein the first control signaling comprises a first chip enable signal and a second chip enable signal, the first control pins comprise a first chip enable pin coupled to the buffer chip and the first group of memory devices and a second chip enable pin coupled to the buffer chip and the second group of memory devices, and wherein the memory controller is configured to:
in response to determining that the buffer chip is in a legacy mode, transmit the first chip enable signal from the first chip enable pin and the second chip enable signal from the second chip enable pin.

15. The memory controller of claim 13, wherein the second control signaling comprises a command latch enable signal and an address latch enable signal, and the second control pins comprise a command latch enable pin and an address latch enable pin coupled to the buffer chip, and wherein the memory controller is configured to:
in response to determining that the buffer chip is in a separate command address (SCA) mode, transmit the command latch enable signal from the command latch enable pin and the address latch enable signal from the address latch enable pin based on an SCA protocol.

16. A method of operating a memory system, comprising:
determining, by a memory controller of the memory system, an operating mode of a buffer chip of the memory system, wherein the buffer chip is coupled to the memory controller and memory devices of the memory system, the operating mode comprises a legacy mode and a separate command address (SCA) mode, and the memory devices comprise a first group of memory devices coupled to the buffer chip through a first data path and a second group of memory devices coupled to the buffer chip through a second data path; and
transmitting, by the memory controller, control signaling to the buffer chip based on the operating mode, wherein the control signaling requests the buffer chip to control the first data path and the second data path.

17. The method of claim 16, wherein transmitting the control signaling to the buffer chip based on the operating mode comprises:
in response to determining that the operating mode is the legacy mode, transmitting a first chip enable signal from a first chip enable pin of the memory controller and a second chip enable signal from a second chip enable pin of the memory controller, wherein the first chip enable signal indicates the buffer chip to enable or disable the first group of memory devices, and the second chip enable signal indicates the buffer chip to enable or disable the second group of memory devices.

18. The method of claim 16, wherein transmitting the control signaling to the buffer chip based on the operating mode comprises:
in response to determining that the operating mode is the SCA mode, transmitting an SCA message using a command latch enable signal and an address latch enable signal, wherein the SCA message comprises a header and a body, the header indicates an SCA message type, and the body indicates the buffer chip to perform one of the following operations:
disabling the first data path and the second data path;
enabling the first data path and disabling the second data path;
disabling the first data path and enabling the second data path; or
enabling the first data path and the second data path.

19. The method of claim 18, wherein the command latch enable signal is transmitted from a command latch enable pin of the memory controller, and the address latch enable signal is transmitted from an address latch enable pin of the memory controller.

20. The method of claim 16, wherein determining the operating mode of the buffer chip comprises:
determining the operating mode of the buffer chip based on a voltage level at a status pin of the buffer chip.
